(19) United States
(12) Patent Application Publication
(10) Pub. No.: US 2004/0243255 A1
(43) Pub. Date: Dec. 2, 2004

(54) Controller for a multi-function appliance

(76) Inventor: Eric Vincent Gonzales, Aurora, IL (US)

Correspondence Address: Robert L. Marsh, P.O. Box 4468, Wheaton, IL, 60189-4468, US

(21) Appl. No.: 10/854,374

(22) Filed: May 26, 2004

Related U.S. Application Data
(60) Provisional application No. 60/473,613, filed on May 27, 2003.

(51) Int. Cl. G05B 11/01; G05B 13/02; G06F 15/00; G06F 15/76

(52) U.S. Cl. 700/14; 700/19; 700/32

(57) ABSTRACT

A controller for an appliance operated by a microprocessor has a rotatable control knob mounted on a shaft that extends through an outer surface of the appliance. A disk with a plurality of apertures spaced around the circumference thereof is mounted on the inner end of the shaft such that the rotation of the control knob generates a succession of signals readable by the microprocessor. Markings around the circumference of the control knob indicate the cycles that the appliance can perform and the various stages of the cycles. Each of the markings has an indicator such as an LED associated therewith and the microprocessor is configured to successively energize the indicator adjacent the marking as the knob is turned and to indicate the indicated cycle or stage when a stage switch is activated.

The applicant claims priority from his co-pending provisional application filed May 27, 2003 and assigned Ser. No. 60/473,613. The present invention relates to a device for controlling an appliance such as a washer or dryer and, in particular, to a rotary controller suitable for use in a machine for which the functions are electronically operated.

### BACKGROUND OF THE INVENTION

Multi-function appliances, such as clothes washing machines, dryers, and dish washing machines, may have a choice of cycles that the machine can perform with each cycle having several stages. Each stage requires the performance of several functions. To operate properly, the functions of the machine must be properly synchronized. For example, a clothes washing machine has a sequence of stages that are carried out to wash knitted clothing and a different sequence of stages to wash permanent press clothing. In the course of a washing stage, the machine will open and close water valves to allow water into the tank of the machine at the beginning of the wash stage and drain it out at the end the wash stage. The wash stage also requires the operation of a motor connected to the agitator while the tank is full of water. Depending on the type of clothing to be washed and the amount of clothing in the machine, the various valves and motors are operated for different intervals of time.

The cycles of existing washing and drying machines are controlled by a mechanical controller having a rotatable knob which is easily accessible to the operator. The knob has a radial flange around the circumference thereof and the flange has markings thereon to identify the stages to be performed in each cycle of the machine. The knob and the associated flange are rotated with respect to a pointer on the surface of the machine. Typically, the flange is divided into arcuate portions. In the case of a washing machine, one arcuate portion of the flange may bear markings for the stages of a cycle for washing permanent press clothing, and a second arcuate portion of the flange may bear markings for the stages in a cycle for washing non-permanent press clothing. An operator will rotate the knob and the flange until the pointer is directed toward the desired cycle or to one of the stages within the cycle, then he will press or pull the knob to turn the machine on. Thereafter, an electric motor connected to the knob rotates the knob and a cylindrical cam mounted thereto. As the knob and cam rotate, protrusions on the cam engage a plurality of switches for turning on or off the various functions of the machine. The rotary cam therefore synchronizes the functions of the machine and the motor that drives the cam serves as a clock, controlling the period of time that the valves are opened and closed and the length of time that the various motors are energized.

The mechanical controller includes the knob, the cam, the motor to drive the cam, and a switch plate with a plurality of switches thereon to be actuated when they are engaged by protrusions on the cam. Such mechanical controllers form a sizable electrical, mechanical assembly; all of which are subject to mechanical failures. Furthermore, whenever a manufacturer desires to alter the sequences of functions for a given cycle of a machine, the entire cam assembly must be re-engineered.

In the meantime, the public has become familiar with the rotary controller currently in use on appliances such as washers and dryers. It would therefore to provide an improved rotary controller that would be operable in substantially the same manner as existing rotary operable controllers but would not be subject to mechanical failure, and that would be useable with a microprocessor to control the machine.

### SUMMARY OF THE INVENTION

Briefly, the invention is embodied in an appliance that is operated by a microprocessor and having a controller for selecting and displaying the cycles of a machine where each of the cycles consists of a plurality of stages and where a plurality of functions are needed to carry out each stage.

An appliance embodying the invention includes a plurality of functions such as opening and closing valves, directing and terminating power to motors and the like, with the functions grouped together to carry out a plurality of stages of a cycle. For example, the stages of the cycle of a clothes washing machine might include wash, rinse, and spin. The various functions which make up the stages of each cycle are controlled by a microprocessor having a memory and a clock for synchronizing the performance of the functions needed to carry out each of the stages thereof.

The appliance has an outer surface and a rotatable shaft extending through the surface of the machine. The shaft has an inner end and an outer end with a knob positioned at the outer end of the shaft for manually rotating the shaft. The outer surface of the machine has markings for designating the cycles the machine can perform and the stages of each cycle; the stages being set forth in the order that they are to be carried out by the machine during the performance of a cycle. Each of the markings designating stages of the cycle has an indicator means adjacent thereto, the indicator means individually energizable by the microprocessor. In the preferred embodiment, the indicator means are LEDs.

At the inner end of the rotatable shaft is a signal-generating means for generating a signal in response to the incremental angular rotation of the shaft. The signals generated on rotation of the shaft are directed to the microprocessor which in turn operates the machine. The controller also includes a switch for commencing the performance of the machine. In the preferred embodiment, the rotatable shaft is axially moveable and the switch is actuated upon axially movement of the shaft.

The microprocessor is configured to successively energize the indicator means on the controller in response to the successive signals generated as the knob is rotated. To select a desired operation, an operator can rotate the knob until the indicator adjacent the stage of the cycle to be performed has been energized, then axially move the shaft to start the cycle. The microprocessor is further configured to carry out the functions of each of the stages of the selected cycle by successively moving to the following stage until the final stage of the cycle has been reached. Upon completion of all the stages of the cycle, all the indicators are de-energized, the machine is returned to the off position, and as off indicator LED is illuminated.

### BRIEF DESCRIPTION OF THE DRAWINGS

A better understanding of the present invention will be had after reading of the following detailed description taken in conjunction with the drawings, wherein:

FIG. 1 is a front elevational view of an appliance having a controller in accordance with the present invention;

FIG. 2 is a fragmentary, enlarged front elevational view of the portion of the surface of the machine shown in FIG. 1 bearing a controller in accordance with the present invention;

FIG. 3 is a front elevational view of one embodiment of the controller shown in FIG. 2 with the control knob shown in broken lines;

FIG. 4 is a cross-sectional view of the controller shown in FIG. 3 taken through line 4-4 thereof;

FIG. 5 is an enlarged, fragmentary cross-sectional view of the optical coupling shown in FIG. 3 taken through line 5-5 of FIG. 4;

FIG. 6 is a block diagram of the elements of the machine shown in FIG. 1;

FIG. 7 is a front elevational view of a second embodiment for the controller shown in FIG. 2.

FIG. 8 is an enlarged, fragmentary front elevational view of the portion of the surface of the machine shown in FIG. 1 bearing a controller in accordance with another embodiment of the invention, the controller having an indicator knob that can be rotated clockwise or counterclockwise to actuation positions shown in broken lines; and

FIG. 9 is a block diagram of the elements of the machine shown in FIG. 1 bearing the embodiment of the invention shown in FIG. 8.

### DETAILED DESCRIPTION OF A PREFERRED EMBODIMENT

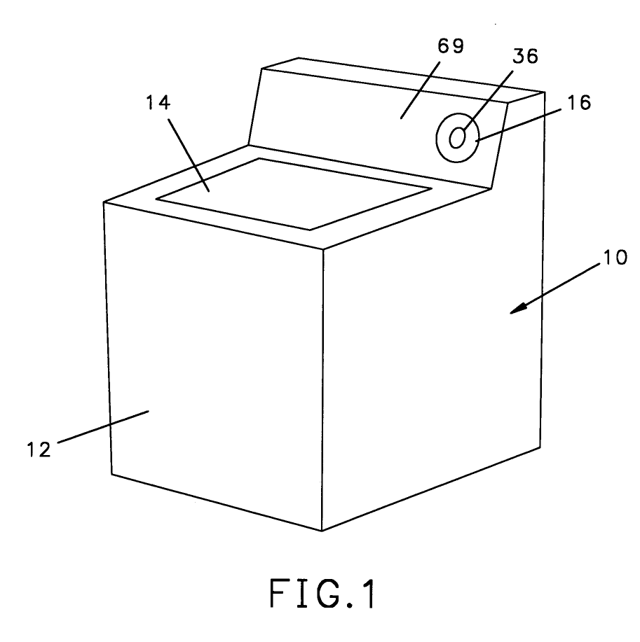

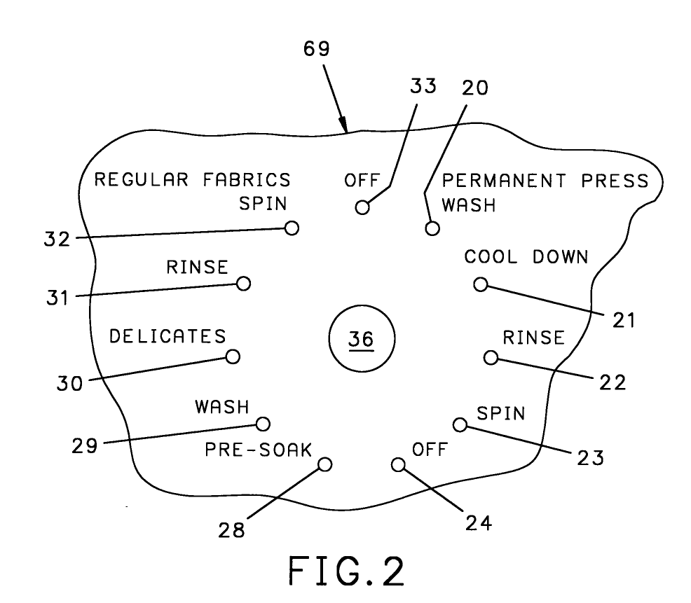

Referring to FIGS. 1 and 2, a typical appliance, such as a clothes washing machine 10, has a housing 12, an access door 14 through which dirty clothing and soap can be inserted into the machine, and a control station 16 for inputting instructions to be carried out by the machine 10.

A clothes washing machine will typically have at least two cycles any of which can be selected by the user of the machine. As depicted in FIG. 2, one of the cycles of the machine 10 is a “permanent press” cycle 18. The stages of the “permanent press” cycle 18 include: “wash”, “cool down”, “rinse”, “spin”, and “off”, with indicator LEDs 20, 21, 22, 23, 24 for designating each of the successive five stages of the permanent press cycle 18. The machine 10 also has a “regular fabric” cycle 26 which has six stages including: “pre-soak”, “wash”, “delicates”, “rinse”, “spin”, and “off”. The six stages of the regular fabric cycle 26 have associated indicator LEDs 28, 29, 30, 31, 32, and 33 for designating the respective stages thereof. In the embodiment depicted, the indicator LEDs 20-24, 28-33 are configured in a circle surrounding a centrally located controller knob 36, which is rotatable in either direction by an operator to select the desired cycle and stage to be performed by the machine 10.

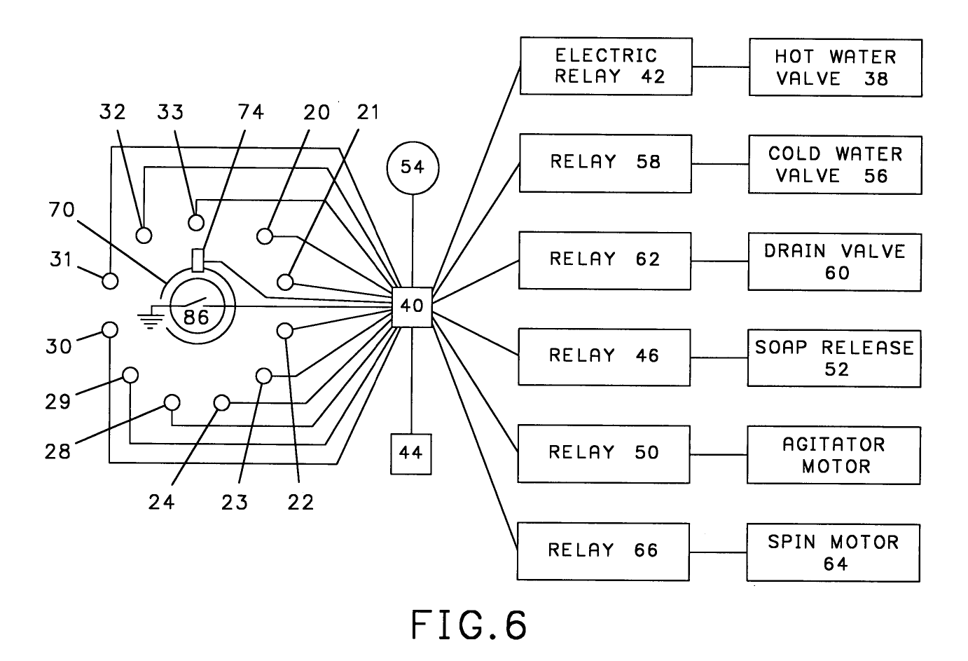

Referring to FIGS. 2 and 6, the various functions of the machine 10 are controlled by a microprocessor 40, and the control station 16 interacts with the microprocessor 40. For example, when the “wash” stage 20 of the permanent press cycle 18 is selected, the associated LED is illuminated and the “wash” stage begins with the filling of the tank, not shown, of the machine with water. To fill the tank, the microprocessor 40 energizes an electronic relay 42 to open a hot water valve 38. When the water in the tank reaches the desired level a water level detector 44 send a signal to the microprocessor 40 after which the electronic relay 42 is deactivated and the hot water valve 38 is closed. The microprocessor 40 next energizes an electronic relay 46 to open a soap release valve 48 to allow the soap in a container, not shown, to be deposited into the tank. The microprocessor 40 then energizes another electronic relay 50 to actuate the agitator motor 52, which continues to operate for a given period of time as determined by the clock 54, after which power to the agitator motor 54 is terminated. Upon termination of the agitator motor 52, the “wash” cycle is complete and the machine 10 shifts to the “cool down” stage and the LED 20 associated with the “wash” stage goes dark and the LED 21 associated with the “cool down” stage 21 is then illuminated.

The machine 10 then carries out the functions related to the cool down stage. To carry out the various functions of all the stages of the two cycles 18, 26, the machine also has a cold water valve 56 and an associated electronic relay 58, a drain valve 60 and an associated electronic relay 62, a spin motor 64 and an associated electronic relay 66, and all of the electronic relays 40, 46, 50, 58, 62, 66 are controlled by the microprocessor 40 in accordance with a predetermined logic.

Referring to FIGS. 2, 3, 4, and 5, the rotatable knob 36 is mounted on a shaft 68 that extends through the metal outer surface 69 of the machine 10. Fixed for rotation with the shaft 68 is a coaxial, circular disk 70 having a plurality of apertures 72-72 spaced around the circumference thereof. Fitted around the edge of the disk 70 is an optical coupling 74 consisting of an LED 76 for transmitting optical light and a pair of adjacent photodiodes 78, 80 for receiving the optical light from the transmitter 76 that passes through one of the apertures 72-72 of the disk 70. The rotation of the knob 36 will therefore cause the rotation of the disk 70 and the movement of apertures 72-72 between the optical coupling 74 and will generate a plurality of pulses that are received by the microprocessor 40.

Referring to FIG. 5, in one embodiment of the invention two photodiodes 78, 80 are positioned in side-by-side relationship along the arc scribed by the apertures 72-72 in the disk 70. As a result, the rotation of the shaft 68 and the disk 70 will move the apertures 72-72 between the LED 76 and the photodetectors 78, 80, and will successively illuminate the photodiodes 78, 80. By determining which of the photodiodes 78, 80 is first illuminated, the microcomputer 40 can determine the direction of the rotation of the disk 70.

Referring further to FIGS. 2 and 6, the LEDs 20-24, 28-33 are individually energizable by the microprocessor 40 as the control knob 36 is rotated. The microprocessor 40 has a start position, for example, the “off” position 33 of the regular fabric cycle 26 which is depicted as positioned immediately above the shaft 68. The microprocessor 40 can be configured to illuminate the “off” LED 33 whenever the machine is not in operation. One who desires to operate the machine will commence by rotating the control knob 36 clockwise or counterclockwise, causing the apertures 72-72 on the disk 70 to move between the LED 76 and the photodiodes 78, 80 and providing pulses to the microprocessor 40. If the operator begins by rotating the knob in the counterclockwise direction, the microprocessor 40 will first darken the “off” LED 33 and then illuminate the “spin” LED 32. Continued rotation of the control knob 36 will result in the illumination of the “rinse” LED 31 and the darkening of the “spin” LED 32. An operator of a washing machine who desires to wash regular fabrics in the machine 10 will continue to rotate the control knob 36 in the counterclockwise direction until the “wash” LED 29 or the “pre-soak” LED 28 is illuminated. When the LED for the stage the operator wishes the machine to perform is illuminated, the operator will then energize the start button 86 of the machine 10 and the machine will perform the selected stage of a cycle.

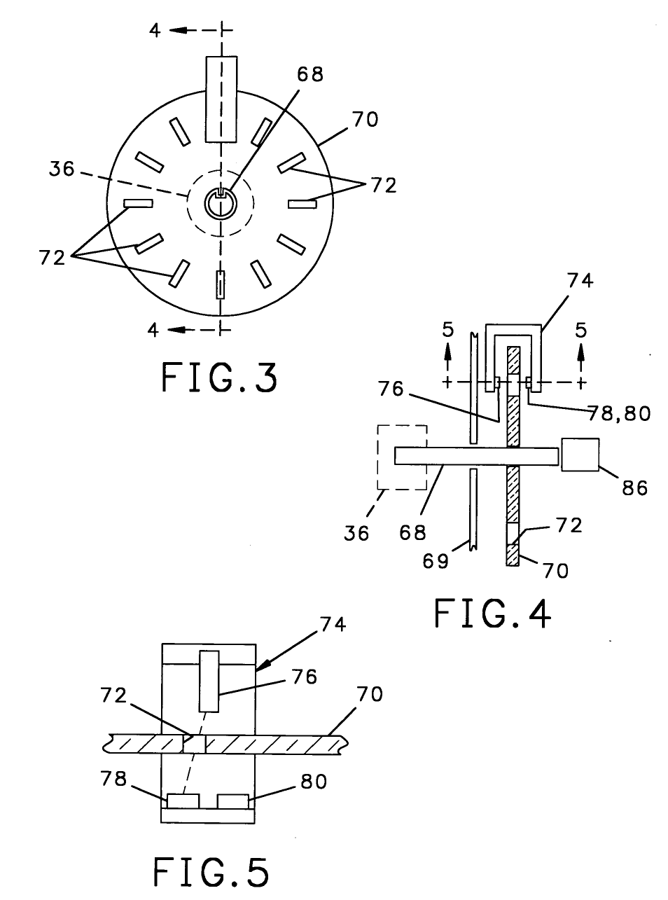

Referring to FIGS. 2 and 3, the number of apertures 72-72 spaced around the circumference of the disk 70 can be equal to the number of indicator LEDs 20-24, 28-33. Rotation of the control knob 36 through 360 degrees will therefore cause the darkening of the initially illuminated LED, (in most cases the Off LED 33 will be initially illuminated) and the successive illumination of all the LEDs 20-2-, 28-33 until the initial LED is again illuminated.

In the preferred embodiment, the rotatable shaft 68 is axially moveable and the start switch 86 is actuated by depressing the knob 36 thereby axially moving the shaft 68 and actuating the switch 86. The structure of the axially moveable shaft 68 and the switch 86 are not shown, although controls having a rotatable selector knob and an axially moveable shaft to activate a switch are well known in the art.

The microprocessor 40 is configured to carry out the functions of the stage indicated by the illuminated LED 20-24, 28-33. Upon completion of all the functions of a first stage, the microprocessor 40 will darken the LED for the first stage and illuminated the LED for the succeeding stage. The microprocessor 40 will then operated the functions of the machine to carry out the succeeding stage. After all the stages of a cycle have been completed, the microprocessor 40 will illuminated and LED indicating that the machine is off. The machine 10 is depicted as having a first “off” LED 33 that is illuminated at the end of a regular fabric cycle 26 to indicate that the machine is off and a second “off” LED 24 at the end of the permanent press cycle 18, but it must be appreciated that the machine 10 can be configured with only one LED indicating that the machine is “off” with that one LED illuminated at the end of either cycle 18, 26.

The microprocessor 40 can detect either clockwise and counterclockwise rotation of the knob 36 and therefore, the knob 36 can be rotated in either direction to successively illuminated the LEDs 20-24, 28-33 until the desired stage of a cycle is reached. Once the LED for the desired stage is illuminated, the knob 36 is depressed and the functions of the machine will be initiated to carry out the selected stage.

The microprocessor 40 of the machine 10 may also be configured to illuminate the LEDs for all the stages to be performed in a given cycle once the cycle has been selected. In this configuration, the operator will rotate the selector knob 36 in either the clockwise or counterclockwise direction until the LED near the first stage of the cycle that the operator wants performed has been illuminated. When the start switch 86 is actuated, the microprocessor 40 will illuminate all the LEDs for the remaining stages of the cycle. If, for example, the sector knob 36 is rotated until the LED 20 for the “wash” stage of the “permanent press” cycle has been illuminated and the start switch 86 activated, the “wash” LED 20 will remain illuminated and all the LEDs for the remaining stages of the permanent press cycle will become illuminated, namely, the “cool down” LED 21, the “rinse” LED 22, the “spin” LED 23, and the “off” LED 24. As the machine 10 completes the performance of each of these stages, the LED for the completed stage will go dark until the entire cycle has been completed and only the “off” LED remains illuminated.

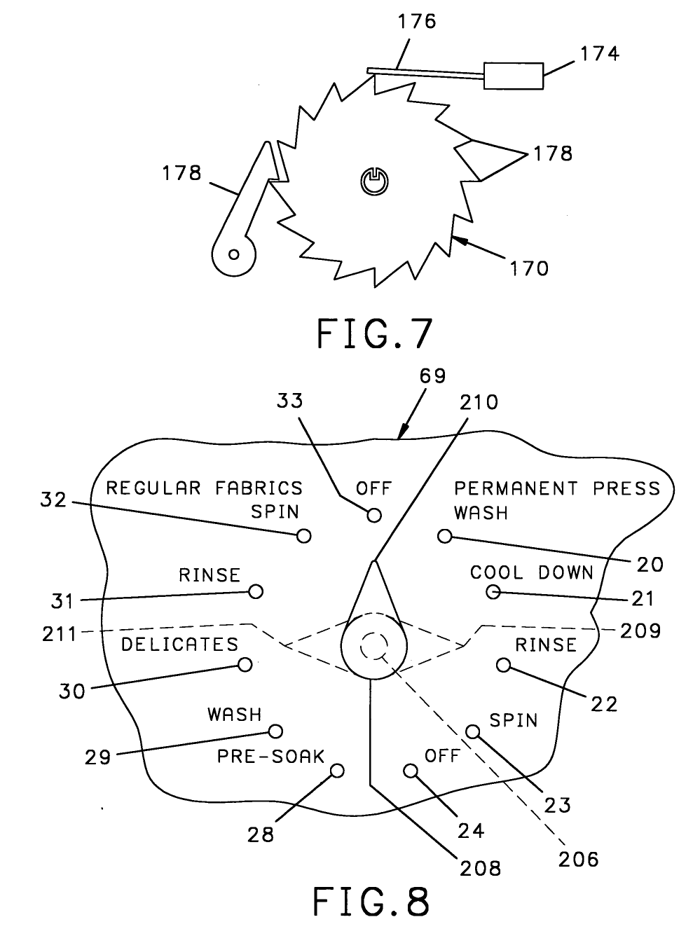

The invention is not limited to the use of the photocoupler 74 consisting of the LED 76 and the photodiodes 78, 80. Any method by which the microprocessor 40 can monitor the rotational movement of the shaft 68 will enable the microcomputer 40 to successively illuminated the LEDs 20-24, 28-33 and thereby display the cycle and stage selected to be carried out by the machine. For example, the rotational movement of the shaft 68 may be monitored by actuating a mechanical switch as shown in FIG. 7. In this embodiment, the rotatable shaft 168 is mounted to a gear or cam 170 having ratchet teeth 172-172. An actuator switch 174 has an actuating arm 176 that is actuated each time it is engaged by one of the teeth 172-172 of the cam 170. Rotation of the shaft 168 will therefore cause the teeth 172-172 to successively engage the arm 176, and the switch 174 will provide a series of pulses to the microprocessor 40.

In this embodiment, the ratchet teeth 172-172 are also engaged by a pawl arm 178 to permit rotation of the cam 170 in one direction only and therefore the microprocessor 40 need only detect the succession of pulses from a single detector, namely switch 174.

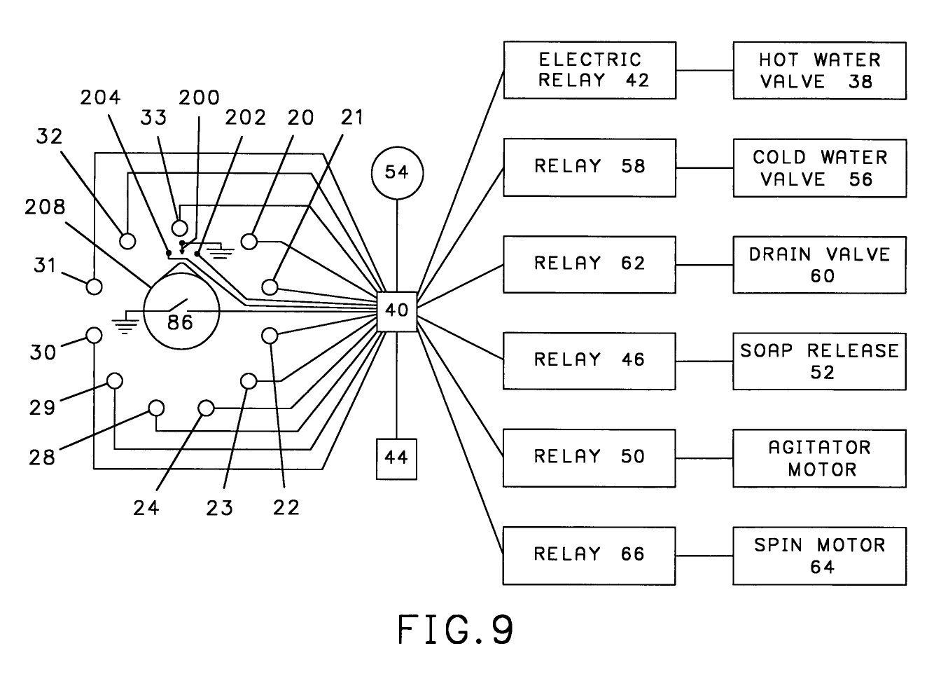

Referring to FIGS. 8 and 9, in place of the knob 36 and the pulse generating devices described above, the invention may employ a switch 200 having two poles 202, 204 that are activated by rotation of a shaft 206 (shown in broken lines in FIG. 8) extending through the body 12 of the machine 10 with an actuator knob 208 on the outer end thereof. The knob 208 and the shaft 206 can be rotated clockwise from a central open position 210 approximately 90 rotated degrees to a second position 209 to close the contacts of the first pole 202 and can be approximately 90 degrees counterclockwise from the central open position to a third position 211 to close the contacts of the second pole 204. The shaft 206 is spring biased to return to the central open position 210 when the knob 208 is not being manually rotated to close one of the poles 202, 204. Spring loaded rotatable two pole switches such as switch 200 are well known in the art and therefore the structure of the spring assembly that urges the shaft 206 to rotate back to the central open position 210 is not depicted.

In this embodiment, the two pole rotatable switch 200 is provided in substitution for the rotatable shaft 68, the disk 70, and the optical coupler 74. The clock 54 of the microprocessor is employed to measure the time that contacts of either of the poles 202, 204 remain closed and the microprocessor 40 divides the time into finite segments of about one-half second each. The microprocessor 40 then treats each one-half second segment of time that one of the poles 202, 204 remains closed as a separate pulse. The microprocessor will then begin with a start position, typically illuminating the “off” LED 33 as a start position, and successively darkens one LED and illuminates a succeeding LED for each half second that the contacts of one of the poles 202, 204 remains closed. The microprocessor 40 is configured to read the closing of the contacts of the first pole 202 as indicating a clockwise rotation of the knob 208 and will first illuminate LED 20, the LED 21, and so forth moving around the knob in the clockwise direction. The microprocessor 40 is also configured to read the closing of the contacts of the second pole 204 as indicating a counterclockwise rotation of the knob 208 resulting in the illumination of the LED in the reverse order.

As can be seen, the controller knob 36 or 208 of the control station 16 can be used to select the cycle to be performed by the machine 10 and the stage of the cycle at which the machine 10 is to commence operating. A machine with an electronic control station 16 in accordance with the present invention can be readily modified to accommodate changes or improvements to the machine 10 by simply adding or subtracting the number of LEDs that surround the knob 36 and reconfiguring the microprocessor 40. The re-engineering of a cam and switch assembly, as was needed with the prior art mechanical rotary selectors is not required.

While the invention is described with respect to two embodiments, it will be appreciated that many modifications and variations may be made without departing from the true spirit and scope of the invention. It is therefore the intent of the appended claims to cover all the variations and modifications that fall within the spirit and scope of the invention.

What is claimed:

1. A controller for selecting and carrying out the cycles of a machine where each said cycle includes one or more functions and said functions are electronically operated, said controller comprising
a microprocessor for synchronizing said functions and operating said functions,
a shaft extending through an outer surface of said machine,
said shaft having an inner end and an outer end,
means on said outer end for manually turning said shaft,
markings on said outer surface designating said cycles of said machine,
said markings being arranged in a sequence corresponding to the order in which said cycles are to be carried out by said machine,
indicator means adjacent each of said markings, said indicator means individually energizable by said microprocessor,
start means for generating a start signal,
means for generating a plurality of successive signals in response to the turning of said shaft in a first direction,
said microprocessor responsive to said start means and said means for generating a plurality of successive signals, said microprocessor successively energizing said indicator means one at a time sequentially in response to said successive signals and said microprocessor initiating said cycle for which said indicator means is energized in response to said start signal.

2. The controller of claim 1 wherein said microprocessor will successively energize all of said indicator means adjacent said markings in response to the rotation of said shaft through 360 degrees.

3. The controller of claim 1 wherein said means for generating a plurality of successive signals further comprises
a plurality of means on said disk for energizing said detector as said disk is rotated near said detector.

4. The controller of claim 3 wherein said stationary detector is a photodetector and said means for energizing are a plurality of apertures spaced around a circumference of said disk.

5. The controller of claim 1 wherein said means for generating a plurality of successive signals comprises a cam mounted on said shaft and a switch activated by rotation of said cam.

6. The controller of claim 1 wherein said means for generating a plurality of successive signals comprises
a switch having a rotatable activator shaft for closing said switch,
a clock for measuring an interval of time during which said switch remains closed, and
said microprocessor configured to divide said interval of time into a series of predetermined time intervals and to respond to said series of time intervals as successive signals.
